(19) United States
(12) Patent Application Publication
(10) Pub. No.: US 2021/0076280 A1
(43) Pub. Date: Mar. 11, 2021

(54) SYSTEM AND METHOD FOR PROVIDING ASSISTANCE DATA TO A RADIO ACCESS NETWORK

(71) Applicant: Sony Corporation, Tokyo (JP)

(72) Inventors: Lars NORD, Lund (SE); Anders BERGGREN, Lund (SE); Basuki PRIYANTO, Lund (SE); Rickard LJUNG, Lund (SE)

(21) Appl. No.: 17/049,311

(22) PCT Filed: May 26, 2019
(86) PCT No.: PCT/SE2019/050482

§ 371 Date: Oct. 20, 2020

(30) Foreign Application Priority Data
Jun. 13, 2018 (SE) 1830191-1

(51) Int. Cl. H04W 36/14; H04W 36/30; H04W 28/24; H04W 28/02; H04W 88/06

(52) U.S. Cl. CPC H04W 36/14; H04W 36/30; H04W 88/06; H04W 28/0268; H04W 28/24

(57) ABSTRACT

A radio access network (RAN) node (130) of a first wireless access network (106) of a wireless communication network (102), the RAN node having a first radio link with a user equipment (100). The RAN node is configured to receive, from a core network (104) of the wireless communications network, radio link information related to a second radio link established between the user equipment and a second wireless access network (134) different than the first wireless access network, the radio link information including at least one of availability of the second radio link to the user equipment or quality of the second radio link.

### TECHNICAL FIELD OF THE INVENTION

The technology of the present disclosure relates generally to cellular network operation and, more particularly, to a system and method for providing assistance data relating to multi-access connection of a user equipment from a core network to a radio access network, such data may be used by the radio access network to improve service provided by the cellular network.

### BACKGROUND

An issue for radio access network (RAN) nodes is that they can become overloaded at a particular time while one or more neighboring RAN nodes are not overloaded. Also, degradation of the radio link between a base station and a user equipment (UE) may result in actions such as handover to another base station, scheduling of coverage enhancement (CE) toward the UE, reducing modulation order, or increasing power consumption by the UE used for signal transmission. These solutions tend to consume network resources and/or over the air resources. RANs may make servicing decisions to improve collective performance, such as conducting network load balancing and distributing UEs with varying CE levels.

Other solutions focus on directing data through a different network to which the UE has an operative connection. For example, in the 3rd Generation Partnership Project (3GPP) system architecture 2 (SA2) planning for 5G, a study called access traffic selection steering and splitting (ATSSS) has been undertaken. ATSSS is also referred to as an access traffic selection steering and splitting function (AT3SF). ATSSS (interchangeably referred to as AT3SF herein) is a core network (CN) function targeted to provide policies for the UE to select network access from two or more connected networks under specific conditions. The selecting and steering functionality has significant similarities to the legacy functionality called access network discovery and selection function (ANDSF), but the main objective of ANDSF is to provide decision rules and policies to the UE. AT3SF provides an additional core network function in the splitting of data traffic between radio networks.

The splitting means that an ongoing protocol data unit (PDU) session may be split over a 3GPP access (e.g., a network operating in accordance with a 3GPP specification) and a non-3GPP access, such as WiFi network access. The traffic for the PDU session is then split between the two accesses. In order for the core network related to the 3GPP access to make splitting decisions, it has been proposed that the UE send radio access to measurement reports to the AT3SF in the core network.

As another example, 4G provides for long term evolution (LTE)-wireless local area network (WLAN) aggregation (LWA). LWA resides in the RAN node and has two accesses, including an LTE/evolved universal terrestrial radio access (E-UTRA) access and a WLAN access. In LWA, the UE reports radio link quality for both accesses using a measurement report between the UE and the RAN node over one radio control channel.

### SUMMARY

The disclosed systems and methods provide for the 3GPP core network to provide a RAN node with dynamic assistance data related to the connection characteristics between a UE and an alternative radio access technology (e.g., a non-3GPP WLAN).

Since the RAN node may not be aware of the UE's WLAN access, this data serves a fundamental purpose of informing the RAN node of the alternative access. The assistance data also allows the RAN node to support better decision making. For example, the assistance data may be used by the RAN node to perform various functions such as making handover decisions, carrying out network load balancing, and distributing UEs with various CE levels. According to one technique, data from measurement reports received by the AT3SF is sent to the 3GPP RAN node for improved decision making. For instance, in the case of a base station being overloaded, the assistance information may be used to assist the RAN node in distributing the UEs so that the network load in an area becomes more balanced. Also, the RAN node may optimize handover procedures and save signaling resources, while saving power in the UE. In addition, the RAN node may use the assistance information to adapt its own use of unlicensed frequencies.

According to one aspect of the disclosure, a radio access network (RAN) node is configured to operate in a first wireless access network of a wireless communication network and includes: a wireless interface to establish a first radio link between a user equipment and the first wireless access network; an interface to a core network of the wireless communication network; and a control circuit configured to receive, from the core network, radio link information related to a second radio link established between the user equipment and a second wireless access network different than the first wireless access network, the radio link information including at least one of availability of the second radio link to the user equipment or quality of the second radio link.

According to an embodiment of the RAN node, the control circuit is further configured to: assess quality of the first radio link; and determine, in accordance with the quality of the first radio link and at least one of availability of the second radio link to the user equipment or quality of the second radio link, whether to continue to service the user equipment via the first radio link.

According to an embodiment of the RAN node, the determination whether to continue to service the user equipment via the first radio link is further made in accordance with at least one of network load distribution of the first wireless access network or ability of another base station to service the user equipment at a certain quality of service (QoS).

According to an embodiment of the RAN node, upon determination to discontinue servicing the user equipment via the first radio link, release the user equipment.

According to an embodiment of the RAN node, release of the user equipment is made instead of handing over the user equipment to another base station of the first wireless access network.

According to an embodiment of the RAN node, release of the user equipment is made instead of one of scheduling resources to perform enhanced coverage operation for the user equipment, altering signal modulation, or increasing transmit power at the user equipment.

According to an embodiment of the RAN node, the radio link information related to the second radio link is received from a traffic steering and/or splitting function of the core network.

According to an embodiment of the RAN node, the second wireless access network includes both a control plane and a user plane separate from a control plane and a user plane of the first wireless access network.

According to another aspect of the disclosure, a method of providing service to a user equipment by a radio access network (RAN) node that operates in a first wireless access network of a wireless communications network includes: establishing a first radio link between the user equipment and the RAN node; and receiving, at the RAN node and from a core network of the wireless communication network, radio link information related to a second radio link established between the user equipment and a second wireless access network different than the first wireless access network, the radio link information including at least one of availability of the second radio link to the user equipment or quality of the second radio link.

According to an embodiment of the method, the method further includes: assessing quality of the first radio link; and determining, in accordance with the quality of the first radio link and at least one of availability of the second radio link to the user equipment or quality of the second radio link, whether to continue to service the user equipment via the first radio link.

According to an embodiment of the method, the determination whether to continue to service the user equipment via the first radio link is further made in accordance with at least one of network load distribution of the first wireless access network or ability of another base station to service the user equipment at a certain quality of service (QoS).

According to an embodiment of the method, upon determination to discontinue servicing the user equipment via the first radio link, release the user equipment.

According to an embodiment of the method, release of the user equipment is made instead of handing over the user equipment to another base station of the first wireless access network.

According to an embodiment of the method, release of the user equipment is made instead of one of scheduling resources to perform enhanced coverage operation for the user equipment, altering signal modulation, or increasing transmit power at the user equipment.

According to an embodiment of the method, the radio link information related to the second radio link is received from a traffic steering and/or splitting function of the core network.

According to an embodiment of the method, the second wireless access network includes both a control plane and a user plane separate from a control plane and a user plane of the first wireless access network.

According to another aspect of the disclosure, a core network server of a wireless communications network includes a processor that executes logical operations to: execute a traffic steering and/or splitting function of the core network directed toward a user equipment serviced over a first radio link by a radio access network (RAN) node of a first wireless access network of the wireless communications network; receive radio link information related to a second radio link established between the user equipment and a second wireless access network different than the first wireless access network, the radio link information including at least one of availability of the second radio link to the user equipment or quality of the second radio link; and communicate the radio link information to the RAN node.

According to an embodiment of the core network sever, the executed logical operations further include detect that the user equipment has been released by the RAN node and steer data traffic to the user equipment via the second radio link.

### BRIEF DESCRIPTION OF THE DRAWINGS

FIG. 1 is a schematic diagram of an operational network environment for an electronic device, also referred to as a user equipment.

FIG. 2 is a schematic diagram of a radio access network (RAN) node in the network environment.

FIG. 3 is a schematic diagram of a core network function server in the network environment.

FIG. 4 is an exemplary flow diagram of operations carried out by a traffic selection steering and splitting function hosted by the core network server.

FIG. 5 is an exemplary flow diagram of operations carried out by the RAN node.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### System Architecture

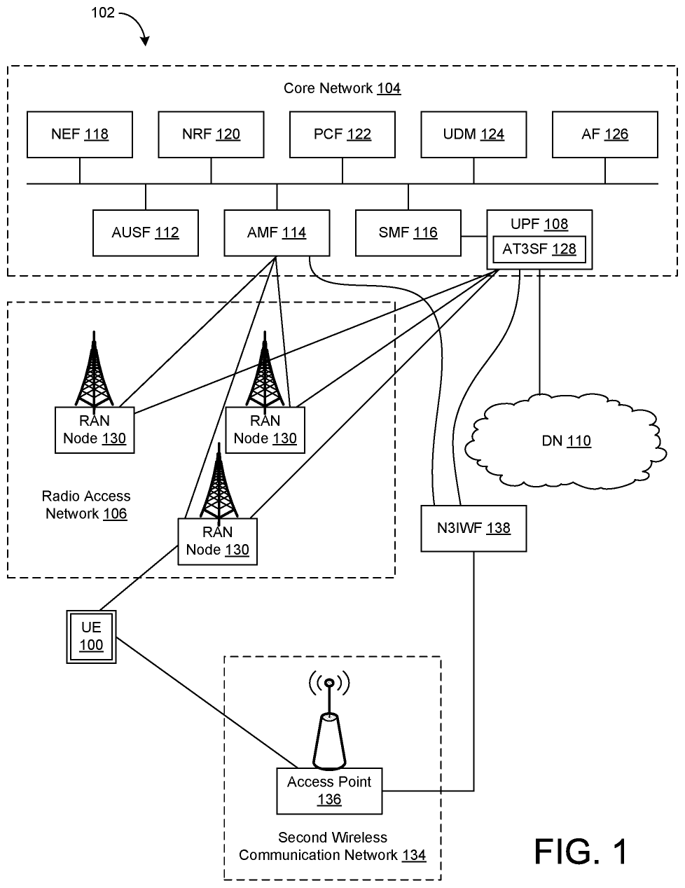

FIG. 1 is a schematic diagram of an exemplary network environment in which the disclosed techniques are implemented. It will be appreciated that the illustrated network environment is representative and other environments or systems may be used to implement the disclosed techniques. Also, functions disclosed as being carried out by a single device, such as the disclosed core network server, may be carried out in a distributed manner across nodes of a computing environment.

The network environment relates to an electronic device, such a user equipment (UE) 100. As contemplated by 3GPP standards, the UE may be a mobile radiotelephone (a “smartphone”). Other exemplary types of UEs 100 include, but are not limited to, a gaming device, a media player, a tablet computing device, a computer, and an internet of things (IoT) device that communicates using machine-to-machine (M2M) communications or machine-type communications (MTC).

The network environment includes a wireless communication network 102 that is configured in accordance with one or more 3GPP standards, such as a 3G network, a 4G network or a 5G network. The wireless communication network 102 also may be referred to as a 3GPP network 102. The 3GPP network 102 includes a core network (CN) 104 and a radio access network (RAN) 106. As will become more apparent from the following discussion, the RAN 106 may be referred to as a first wireless access network 106. FIG. 1 is a service-based representation to illustrate the 3GPP network 102, but other representations are possible, such as a reference point representation. The CN 104 includes a user plane function (UPF) 108 that provides an interface to a data network (DN) 110, which represents operator services, connection to the Internet, third party services, etc.

The core network 104 includes one or more servers that host a variety of functions, illustrated examples of which include, but are not limited to, the UPF 108, an authentication server function (AUSF) 112, a core access and mobility management function (AMF) 114, a session management function (SMF) 116, a network exposure function (NEF) 118, a network repository function (NRF) 120, a policy control function (122), a unified data management (UDM) 124, and an application function (AF) 126. In one embodiment, an AT3SF 128 is part of the UPF 108. Some aspects of the AT3SF 128 may be distributed in other CN functions.

The RAN 106 includes a plurality of RAN nodes 130. Each RAN node 130 may be a base station such as an evolved node B (eNB) base station or a 5G generation gNB base station. A first radio link may be established between the UE 100 and one of the RAN nodes 130, which will be referred to as the servicing RAN node 130 or servicing base station. Other RAN nodes 130 may be within communication range of the UE 100.

The RAN 106 is considered to have a user plane and a control plane, the control plane implemented with radio resource control (RRC) signaling between the UE 100 and the RAN node 130. Another control plan between the UE 100 and the CN 104 is present and implement with non-access stratum (NAS) signaling.

The UE 100 also may have a second radio link established with a second wireless access network 134. The second access network 134 is separate from the first access network 106 and may be, for example, a WiFi network operating in accordance with IEEE 802.11. Hence, the second wireless access network 134 may be considered a non-3GPP access. It will be understood that the second wireless access network 134 may operate in accordance with standards other than IEEE 802.11, including those adopted by the 3GPP. In one embodiment, the second wireless access network 134 has both a control plane (e.g., a WiFi radio control plane) and a user plane that are separate from a control plane (the 3GPP radio control plane implemented with RRC) and a user plane of the first wireless access network 106.

In the illustrated embodiment, the second wireless access network 134 includes an access point 136, such as a router and modem, with which the UE 100 establishes the second radio link. The second wireless access network 134 may interface with the 3GPP core network 104 via a non-3GPP inter-working function (N3IWF) 138.

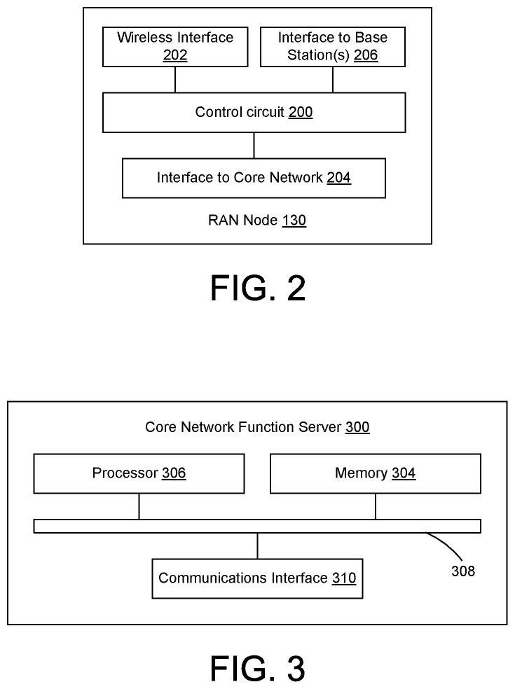

With additional reference to FIG. 2, illustrated is a schematic block diagram of the RAN node 130. The RAN node 130 includes a control circuit 200 that is responsible for overall operation of the RAN node 130, including controlling the RAN node 130 to carry out the operations described in herein. In an exemplary embodiment, the control circuit 200 may include a processor (e.g., a central processing unit (CPU), microcontroller, or microprocessor) that executes logical instructions (e.g., lines or code, software, etc.) that are stored by a memory (e.g., a non-transitory computer readable medium) of the control circuit 200 in order to carry out operation of the RAN node 130.

The RAN node 130 includes a wireless interface 202, such as a radio transceiver, for establishing an over the air connection with the UE 100. The RAN node 130 also includes an interface 204 to the core network 104, which typically includes operative connectivity to the AMF 114 and the UPF 108. The RAN node 130 also includes an interface 206 to one or more neighboring RAN nodes 130 for conducting network coordination in the RAN 106.

With additional reference to FIG. 3, illustrated is a schematic block diagram of a core network function server 300 of the core network 104 that executes logical instructions (e.g., in the form of one or more software applications) to carry out one or more of the functions of the core network 104. For instance, the server 300 may execute software that embodies the AT3SF 128. It will be understood, however, that aspects of the AT3SF 128 may be distributed across nodes of a computing environment.

The server 300 may be implemented as a computer-based system that is capable of executing computer applications (e.g., software programs) that, when executed, carry out functions of the server 300. As is typical for a computing platform, the server 300 may include a non-transitory computer readable medium, such as a memory 304 that stores data, information sets and software, and a processor 306 for executing the software. The processor 306 and the memory 304 may be coupled using a local interface 308. The local interface 308 may be, for example, a data bus with accompanying control bus, a network, or other subsystem. The server 300 may have various input/output (I/O) interfaces for operatively connecting to various peripheral devices, as well as one or more communications interfaces 310. The communications interface 310 may include for example, a modem and/or a network interface card. The communications interface 310 may enable the server 300 to send and receive data signals to and from other computing devices in the core network 104 and/or in other locations as is appropriate.

### RAN Node Assistance Operations

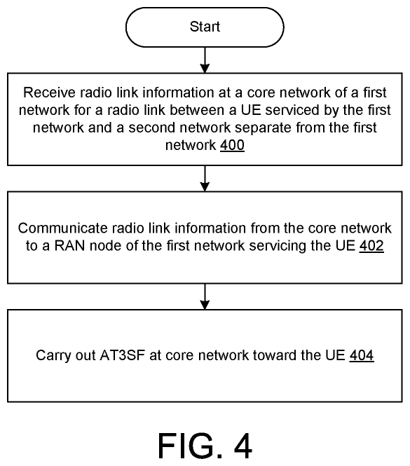

With additional reference to FIG. 4, shown is an exemplary flow diagram representing steps that may be carried out by the server 300 when executing logical instructions to provide assistance data to the RAN node 130. FIG. 4 illustrates an exemplary process flow representing steps that may be embodied by the AT3SF 128. Complimentary operations of the UE 100 and/or the RAN node 130 also will be understood from this disclosure. Although illustrated in a logical progression, the illustrated blocks of FIG. 4 may be carried out in other orders and/or with concurrence between two or more blocks. Therefore, the illustrated flow diagram may be altered (including omitting steps) and/or may be implemented in an object-oriented manner or in a state-oriented manner.

The logical flow may start in block 400 where the server 300 receives radio link information for the second radio link between the UE 100 and the second wireless access network 134. The radio link information may be collected by the UE 100 and reported to the AT3SF 128 for use in traffic steering and/or splitting. The UE 100 also may report information concerning the first radio link between the UE 100 and the RAN 106.

In one embodiment, the radio link information for the first radio link and/or the second radio link is reported through a measurement report to support AT3SF. For instance, 3GPP TR23.793 proposes a measurement signaling protocol between the UE 100 and the AT3SF 128 that includes the sending of a measurement report (AT3SF_MEAS_REPORT) from the UE 100 to the AT3SF 128 with radio link information about the UE's 100 3GPP radio link and the non-3GPP radio link. For a 5G-AN connection type, parameters determined by the UE 100 and set forth in the measurement report may include a reference signal received power (RSRP) value (in dB) and a reference signal received quality (RSRQ) value (in dBm) of the serving 5G-AN. Statistical values based on these or other parameters may be present in the radio link information, such as an average value over a period of time.

For a wireless local area network (WLAN) connection type, parameters determined by the UE 100 and set forth in the measurement report may include WLAN channel utilization (e.g., basic service sets (BSS) load), downlink backhaul available bandwidth, uplink backhaul available bandwidth, and average beacon received signal strength indicator (RSSI).

Other parameters may be determined and communicated to the AT3SF 128 for the 3GPP radio link and/or the non-3GPP radio link. For example, parameters related to the non-3GPP radio link may include an indication of network access availability, a radio link quality indicator based on a throughput metric and/or a jitter metric, a radio link quality indicator based on a radio-type parameter (e.g., RSSI, channel quality indicator (CQI), signal to noise ratio (SNR), etc.), or some other matric.

In block 402, radio link information related to the radio link between the UE 100 and the second wireless access network 134 is communicated from the core network server 300 to the RAN node 130. The data pathway for this communication may be directly between AT3SF 128 and the RAN node 130 or may include other elements, such as the AMF 114 and/or the SMF 116. The radio link information communicated in block 402 may include all the radio link information about the second radio link received at the AT3SF 128 in block 400, a subset of the radio link information about the second radio link received at the AT3SF 128 in block 400, or processed versions of the radio link information about the second radio link received at the AT3SF 128 in block 400 (e.g., statistical calculations).

In block 404, the server 300 carries out AT3SF operations. These operations may include traffic steering and splitting in accordance with standardized AT3SF protocols. In addition, the traffic steering and splitting may accommodate the event where the RAN node 130 releases the UE 100 instead of conducting a handover, as will be described in greater detail below. In this instance, traffic may be steered through the second wireless access network 134.

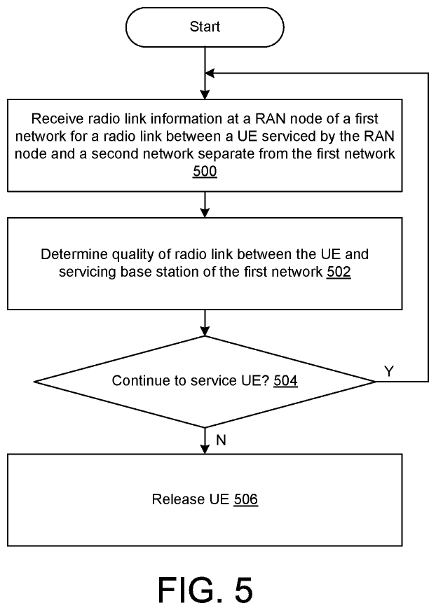

With additional reference to FIG. 5, shown is an exemplary flow diagram representing steps that may be carried out by the RAN node 130 when executing logical instructions to provide wireless radio services to the UE 100 and other UEs 100 with radio links to the RAN 106. FIG. 5 illustrates an exemplary process flow representing steps that may be embodied by the RAN node 130. Complimentary operations of the UE 100 and/or the AT3SF 128 also will be understood from this disclosure. Although illustrated in a logical progression, the illustrated blocks of FIG. 5 may be carried out in other orders and/or with concurrence between two or more blocks. Therefore, the illustrated flow diagram may be altered (including omitting steps) and/or may be implemented in an object-oriented manner or in a state-oriented manner.

The logical flow may start in block 500. In block 500, the RAN node 130 receives the radio link information for the second radio link between the UE 100 and the second wireless access network 134 that was transmitted by the server 300 in block 402. In this manner, the AT3SF 128 conducts dynamic information sharing with the RAN node 130. The information may be used by the RAN node 130 to make better decisions than without this information for addressing issues such as unequal network load among RAN nodes 128, and mobility or deteriorating radio link conditions between UEs 100 and the RAN 106, and for distributing UEs 100 with various CE levels.

The information may be used by the RAN node 130 to determine the quality of the UE's 100 non-3GPP access connectivity. In one embodiment, a determination may be made as to whether the second radio link between the UE 100 and the second wireless access network 134 fulfils or does not fulfil existing PDU session QoS, which may be in terms of guaranteed bit rate and/or jitter requirements. Other types of information may include whether the UE 100 has an active communication session over a non-3GPP radio to link, or other connection characteristics of the non-3GPP radio link such as signal and/or interference levels, an identity of the second wireless access network 134, etc. Since the RAN node 130 with this functionality may be able to determine the quality of the UE's 100 non-3GPP access connectivity and potentially its connection characteristics, the RAN node 130 may take this information into consideration when making handover (HO) decisions, when determining if or how to use alternative frequency bands such as unlicensed radio spectrum, when distributing network load in an area, etc. Exemplary traffic distribution techniques that the RAN node 130 may employ include carrier aggregation (CA), dual connectivity (DC), and license assisted access (LAA).

In one embodiment, servicing decisions regarding the UE 100 may be made, especially when an assessment of the first radio link between the UE 100 and the RAN 106 indicates that this link is degraded. Continuing with the logical flow of FIG. 5, in step 502, the RAN node 130 may determine information about the quality of the first radio link. For example, the servicing base station may make radio link measurements. Alternatively, or additionally, the UE 100 may generate and send radio measurement reports to the RAN node 130 regarding characteristics of the first radio link. As one example, the measurement report may include an ongoing link channel quality indicator (CQI), QoS class identifier (QCI), RSRP, RSRQ and/or other radio link metrics. The measurement report also may include information regarding neighboring cells, such as neighboring cell QCI and/or other radio link metrics.

There may be situations when the quality of the link between the UE 100 and the servicing base station is poor. In normal 3GPP processing, a handover to another base station may occur in this situation. Alternatively, transmissions may be repeated using CE and/or transmit power of the UE 10 may be increased. But there are situations when handing over to a neighboring base station and/or using other measures may not significantly improve link quality. This may occur, for example, when the UE 100 is located in a basement of a building or when the UE 100 near the edge of the respective cells. Even if these actions improve link performance, they often come at a cost of consuming network resources and/or more power consumption in the UE 100.

In one embodiment, the RAN node 130 may take other types of actions based on the information about the alternative network access received in block 500. For example, in block 504, the RAN node 130 may make a determination to discontinue servicing the UE 100. The determination to discontinue servicing the UE 100 may be made as long as the second radio link between the UE 100 and the second wireless access network 134 fulfils minimum link quality criteria, such as satisfying PDU session QoS thresholds or requirements. In one embodiment, the determination to discontinue servicing the UE 100 also may be predicated on a determination that handing over the UE 100 to another base station is unlikely to improve performance.

Discontinuing service may include allowing the first radio link to fail. Alternatively, upon a determination to discontinue servicing the UE 100, the RAN node 130 releases the UE 100 as illustrated in block 506. Releasing the UE 100 may involve releasing the RRC connection over the air connection (e.g., new radio (NR), WCDMA or LTE connection). The determination to discontinue servicing the UE 100 may be made instead of handing over the UE 100 to another base station and/or instead of one or more of scheduling CE resources for the UE 100, altering signal modulation, or increasing UE 100 transmitter output power. Taking the approach of early release would likely save radio resources in the RAN 106 by not keeping communication with the UE 100 and/or not allowing the UE to enter enhanced coverage mode.

Without the receipt of the dynamic assistance information described above, the RAN node 130 would not be able to make the determination to release the UE 100 in this manner. This is because the RAN node 130 would be unaware of the alternative access through the second wireless access network 134 and would, therefore, try to handover the UE 100 to the best neighboring cell even under conditions where the service provided by the new cell would not be very good. But using the assistance information allows the RAN node 130 to make an alternative decision. It is noted that handover decisions are in the control of the RAN 106 and the UE 100 cannot impact this decision.

Upon release of the UE 100, the UE 100 may make attempt to reconnect to the 3GPP network 102. In addition, the UE 100 may continue communication operations and receive data via the second radio link with the second wireless access network 134.

As a result, the RAN 106 may save signaling resources and the UE 100 may save power by not performing handover to a poor cell. Instead, the UE 100 may be sent to RRC_IDLE or RRC_Inactive until the UE 100 detects a new candidate cell for reconnection.

### CONCLUSION

Although certain embodiments have been shown and described, it is understood that equivalents and modifications falling within the scope of the appended claims will occur to others who are skilled in the art upon the reading and understanding of this specification.

1. A radio access network (RAN) node configured to operate in a first wireless access network of a wireless communication network, comprising:
a wireless interface to establish a first radio link between a user equipment and the first wireless access network;
an interface to a core network of the wireless communication network; and
a control circuit configured to receive, from the core network, radio link information related to a second radio link established between the user equipment and a second wireless access network different than the first wireless access network, the radio link information including at least one of availability of the second radio link to the user equipment or quality of the second radio link.

2. The RAN node of claim 1, wherein the control circuit is further configured to:
assess quality of the first radio link; and
determine, in accordance with the quality of the first radio link and at least one of availability of the second radio link to the user equipment or quality of the second radio link, whether to continue to service the user equipment via the first radio link.

3. The RAN node of claim 2, wherein the determination whether to continue to service the user equipment via the first radio link is further made in accordance with at least one of network load distribution of the first wireless access network or ability of another base station to service the user equipment at a certain quality of service (QoS).

4. The RAN node of claim 2, wherein, upon determination to discontinue servicing the user equipment via the first radio link, release the user equipment.

5. The RAN node of claim 4, wherein release of the user equipment is made instead of handing over the user equipment to another base station of the first wireless access network.

6. The RAN node of claim 4, wherein release of the user equipment is made instead of one of scheduling resources to perform enhanced coverage operation for the user equipment, altering signal modulation, or increasing transmit power at the user equipment.

7. The RAN node of claim 1, wherein the radio link information related to the second radio link is received from a traffic steering and/or splitting function of the core network.

8. The RAN node of claim 1, wherein the second wireless access network includes both a control plane and a user plane separate from a control plane and a user plane of the first wireless access network.

9. A method of providing service to a user equipment by a radio access network (RAN) node that operates in a first wireless access network of a wireless communications network, comprising:
establishing a first radio link between the user equipment and the RAN node; and
receiving, at the RAN node and from a core network of the wireless communication network, radio link information related to a second radio link established between the user equipment and a second wireless access network different than the first wireless access network, the radio link information including at least one of availability of the second radio link to the user equipment or quality of the second radio link.

10. The method of claim 9, further comprising:
assessing quality of the first radio link; and
determining, in accordance with the quality of the first radio link and at least one of availability of the second radio link to the user equipment or quality of the second radio link, whether to continue to service the user equipment via the first radio link.

11. The method of claim 10, wherein the determination whether to continue to service the user equipment via the first radio link is further made in accordance with at least one of network load distribution of the first wireless access network or ability of another base station to service the user equipment at a certain quality of service (QoS).

12. The method of claim 10, wherein, upon determination to discontinue servicing the user equipment via the first radio link, release the user equipment.

13. The method of claim 12, wherein release of the user equipment is made instead of handing over the user equipment to another base station of the first wireless access network.

14. The method of claim 12, wherein release of the user equipment is made instead of one of scheduling resources to perform enhanced coverage operation for the user equipment, altering signal modulation, or increasing transmit power at the user equipment.

15. The method of claim 9, wherein the radio link information related to the second radio link is received from a traffic steering and/or splitting function of the core network.

16. The method of claim 9, wherein the second wireless access network includes both a control plane and a user plane separate from a control plane and a user plane of the first wireless access network.

17. A core network server of a wireless communications network, comprising a processor that executes logical operations to:
execute a traffic steering and/or splitting function of the core network directed toward a user equipment serviced over a first radio link by a radio access network (RAN) node of a first wireless access network of the wireless communications network;
receive radio link information related to a second radio link established between the user equipment and a second wireless access network different than the first wireless access network, the radio link information including at least one of availability of the second radio link to the user equipment or quality of the second radio link; and
communicate the radio link information to the RAN node.

18. The core network sever of claim 17, wherein the executed logical operations further include detect that the user equipment has been released by the RAN node and steer data traffic to the user equipment via the second radio link.
